(19) United States
(12) Patent Application Publication
(10) Pub. No.: US 2016/0295307 A1
(43) Pub. Date: Oct. 6, 2016

(54) MASTER-STATION APPARATUS, SLAVE-STATION APPARATUS, CONTROL DEVICE, OPTICAL COMMUNICATION SYSTEM, AND CONNECTION MANAGEMENT METHOD

(71) Applicant: MITSUBISHI ELECTRIC CORPORATION, Chiyoda-ku, Tokyo (JP)

(72) Inventor: Takashi KIKUZAWA, Tokyo (JP)

(73) Assignee: MITSUBISHI ELECTRIC CORPORATION, Chiyoda-ku, Tokyo (JP)

(21) Appl. No.: 15/035,119

(22) PCT Filed: Dec. 13, 2013
(86) PCT No.: PCT/JP2013/083532

§ 371 Date: May 6, 2016

(51) Int. Cl. H04Q 11/00; H04B 10/27

(52) U.S. Cl. CPC H04Q 11/0062; H04Q 11/0067; H04B 10/27; H04Q 2011/0064

(57) ABSTRACT

An OLT including ports connectable to an optical communication path connected to an ONU includes port control units, a setting information management unit that manages setting information for use in communication with the ONU for each of the ports, and a connection management unit that sets setting information managed by the setting information management unit in the port control units. The port control units determine whether to change setting information on the basis of a signal received from the ONU and the setting information that has been set and, when determining that setting information be changed, notify the connection management unit of a request to change setting information, and the connection management unit selects setting information set in the port control units on the basis of the notification from the port control units.

### FIELD

The present invention relates to a master-station apparatus, a slave-station apparatus, a control device, an optical communication system, and a connection management method.

### BACKGROUND

Conventional optical communication systems assign fiber identification information to optical fiber cables and the like and include an optical line management device between the station-side apparatus and the subscriber-side apparatus such that the optical line management device manages the information on connecting locations to manage the connecting locations of the optical fibers (for example, see Patent Literature 1). A method has also been disclosed in which an optical line management device has a switching function and controls connections by changing line connections (see Patent Literature 2).

### CITATION LIST

### Patent Literature

Patent Literature 1: Japanese Patent 4327138

Patent Literature 2: Japanese Patent Application Laid-Open No. 2005-318516

### SUMMARY

### Technical Problem

In such a conventional optical communication system, the setting information for use in communication between the station-side apparatus, which is a master-station apparatus, and the subscriber-side apparatuses, which are slave-station apparatuses, contains the designation of target ports for connection for each subscriber-side apparatus. Consequently, in the case where the station-side apparatus is provided with a plurality of ports, an incorrect fiber connection causes a problem in that communication is disabled because the target ports designated in the setting information and the actually connected ports are different. Additionally, although using an optical line management device to manage the connecting locations enables the detection of an incorrect fiber connection, the optical line management device is required to have functions such as to read fiber identification information and to compare information on the correct connecting locations with the actual connecting locations. This poses a problem in that device costs are incurred. Moreover, when the optical line management device detects an incorrect fiber connection, it switches to the correct connection before restarting the communication, which poses another problem in that it takes time to restart the communication.

The present invention has been achieved in view of the above, and an object of the present invention is to obtain a master-station apparatus, a slave-station apparatus, a control device, an optical communication system, and a connection management method that are capable of suppressing device costs and restarting communication swiftly in the case of an incorrect fiber connection.

### Solution to Problem

In order to solve the above problems and achieve the object, an aspect of the present invention is a master-station apparatus comprising a plurality of ports connectable to an optical communication path connected to a slave-station apparatus, the master-station apparatus including: port control units for the respective ports, the port control units receiving a signal via the ports from the slave-station apparatus and transmitting a signal via the ports to the slave-station apparatus; a setting information management unit that manages, for each of the ports, setting information for use in communication with the slave-station apparatus to be connected to the ports; and a connection management unit that sets the setting information managed by the setting information management unit in the port control unit, wherein the port control unit determines whether or not the setting information be changed on a basis of a signal received from the slave- station apparatus and the setting information that has been set and, when it is determined that the setting information be changed, notifies the connection management unit of a request to change the setting information, and the connection management unit selects setting information to be set in the port control unit from the setting information management unit on a basis of a notification from the port control unit and sets the selected setting information in the port control unit.

### Advantageous Effects of Invention

A master-station apparatus, a slave-station apparatus, a control device, an optical communication system, and a connection management method according to the present invention produce an effect of being able to suppress device costs and restart communication swiftly in the case of an incorrect fiber connection.

### BRIEF DESCRIPTION OF DRAWINGS

FIG. 1 is a diagram illustrating an exemplary configuration of a PON system according to a first embodiment.

FIG. 2 is a diagram illustrating an exemplary configuration of an ONU according to the first embodiment.

FIG. 3 is a flowchart illustrating an exemplary connection management operation of an OLT according to the first embodiment.

FIG. 4 is a diagram illustrating the flow of processing within the OLT in the case of an incorrect connection.

FIG. 5 is a diagram illustrating an exemplary configuration of a PON system according to a second embodiment.

FIG. 6 is a chart diagram illustrating an example in which a link disconnection occurs due to an incorrect connection after a redundancy switchover.

FIG. 7 is a chart diagram illustrating an exemplary operation according to the second embodiment after a switch-back from a redundant system.

FIG. 8 is a flowchart illustrating an exemplary operation of the OLT at a redundancy switch-back.

FIG. 9 is a diagram illustrating an exemplary configuration of a PON system according to a third embodiment.

FIG. 10 is a chart diagram illustrating an exemplary operation according to the third embodiment in the case of an incorrect connection made during a redundancy switch-back.

### DESCRIPTION OF EMBODIMENTS

Exemplary embodiments of a master-station apparatus, a slave-station apparatus, a control device, an optical communication system, and a connection management method according to the present invention will now be described in detail with reference to the drawings. The present invention is not limited to the embodiments.

### First Embodiment

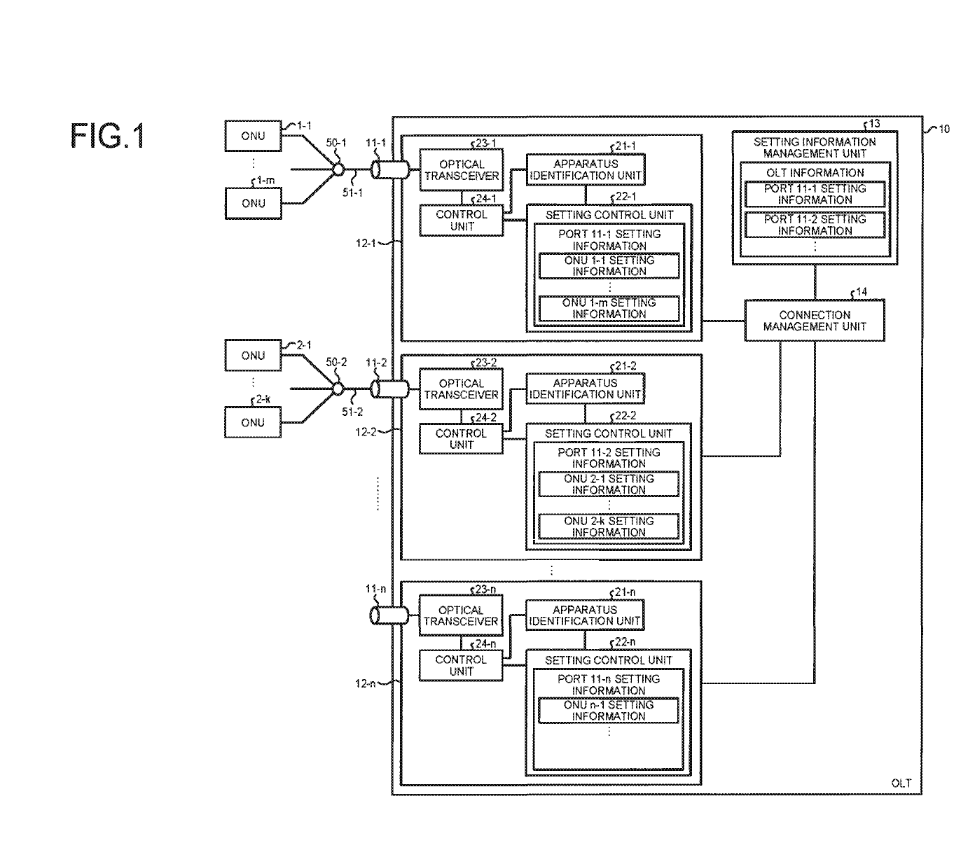

FIG. 1 is a diagram illustrating an exemplary configuration of a PON system (an optical communication system) according to a first embodiment of the present invention. The PON system according to the present embodiment includes user-side optical communication apparatuses (also called an “Optical Network Unit” and hereinafter referred to as “ONU”) 1-1 to 1-m (where m is an integer equal to or greater than one) and 2-1 to 2-k (where k is an integer equal to or greater than one), which operate as slave-station apparatuses, a station-side optical communication apparatus (also called an “Optical Line Terminal” and hereinafter referred to as “OLT”) 10, which operates as a master-station apparatus, and splitters 50-1 and 50-2.

The splitters 50-1 and 50-2 are connected to the OLT 10 via optical fibers (optical communication paths) 51-1 and 51-2, respectively. The splitter 50-1 is connected to the ONUs 1-1 to 1-m via branch line fibers and the splitter 50-2 is connected to the ONUs 2-1 to 2-k via branch line fibers.

The OLT 10 includes ports 11-1 to 11-n (where n is an integer equal to or greater than two), port control units (a control device) 12-1 to 12-n, a setting information management unit 13, and a connection management unit 14. The port control units 12-1 to 12-n correspond to the ports 11-1 to 11-n in a one-to-one manner. In FIG. 1, the port 11-1 is connected to the optical fiber 51-1, and the port 11-2 is connected to the optical fiber 51-2. The ports 11-1 to 11-n are each connectable to one optical fiber. In the example in FIG. 1, the ports 11-1 and 11-2 are connected to the optical fibers 51-1 and 51-2, respectively; however, ports that the optical fibers are connected to are not limited to these ports.

The setting information management unit retains OLT information, which is the setting information and the like for the entire OLT 10, and manages the OLT information. The OLT information contains setting information for each of the ports 11-1 to 11-n (port 11-1 setting information, port 11-2 setting information, and so on). The connection management unit 14 duplicates setting information corresponding to each of the port control units 12-1 to 12-n contained in the OLT information retained in the setting information management unit 13, and inputs the information to the port control units 12-1 to 12-n.

A port control unit 12-i (where i =1, 2, . . ., n) includes an apparatus identification unit 21-i, a setting control unit 22-i, an optical transceiver 23-i, and a control unit 24-i. The optical transceiver 23-i converts an optical signal input from an optical fiber connected to a port 11-i (the optical fiber 51-1 in the example in FIG. 1) to an electric signal and converts an electric signal input from the control unit 24-i to an optical signal and outputs the optical signal to the optical fiber connected to the port 11-i. The control unit 24-i performs processing of the OLT on the basis of a PON protocol. The control unit 24-i generates a signal to be transmitted to an ONU connected to the optical fiber connected to the port 11-i and inputs the signal to the optical transceiver 23-i. The control unit 24-i also performs processing on the basis of a signal received from an ONU via the optical transceiver 23-i.

The setting control unit 22-i retains the setting information for a port corresponding to the setting control unit 22-i (port 11-setting information) input from the setting information management unit 13. The port 11-setting information contains setting information for each ONU connected to the port 11-(ONU 1-1 setting information, ONU 1-2 setting information, and the like). The setting information for each ONU contains specific information on each ONU (for example, a MAC (Media Access Control) address, transfer process setting as for VLAN (Virtual Local Area Network), service information relating to bandwidth allocation, and the like for each ONU). The apparatus identification unit 21-i compares ONU specific information stored in a signal received from an ONU via the optical fiber connected to the port 11-with the setting information of each ONU in the port 11-setting information retained in the setting control unit 22-i and, if there is a match, performs setting corresponding to the ONU on the basis of the matched setting information.

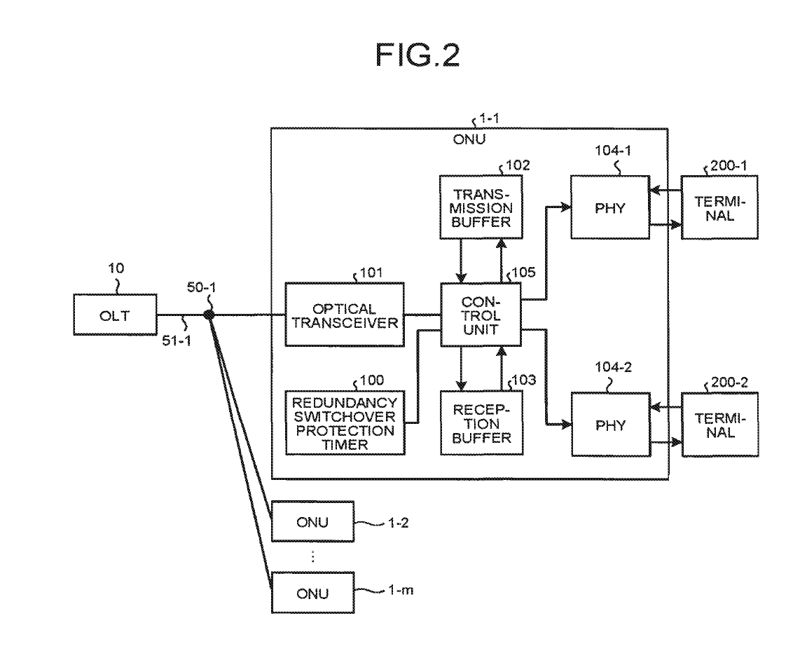

FIG. 2 is a diagram illustrating an exemplary configuration of the ONU 1-1 according to the present embodiment. The configurations of the ONUs 1-2 to 1-m are similar to that of the ONU 1-1. The configurations of the ONUs 2-1 to 2-k connected to the port 11-2 are also similar to that of the ONU 1-1. in the example in FIG. 2, the ONU 1-1 is connected to terminals 200-1 and 200-2; however, the number of terminals connected to the ONU 1-1 is not limited to that in the example. Alternatively, no terminal may be connected.

The ONU 1-1 includes a redundancy switchover protection timer 100, an optical transceiver 101, a transmission buffer 102, a reception buffer 103, physical layer processing units (PHY) 104-1 and 104-2, and a control unit 105. The optical transceiver 101 receives an optical signal transmitted by the OLT 10 via the optical fiber 51-1, the splitter 50-1, and the branch line fiber and converts the received optical signal to an electric signal. The optical transceiver 101 also converts an electric signal input from the control unit 105 to an optical signal and transmits the optical signal to the OLT 10 via the branch line fiber, the splitter 50-1, and the optical fiber 51-1. The control unit 105 performs processing of the ONU on the basis of the PON protocol. The control unit 105 generates a signal to be transmitted to the OLT and inputs it to the optical transceiver 101, and performs processing on the basis of a signal input from the optical transceiver 101.

The transmission buffer (upstream buffer) 102 is a buffer to store transmission data to be transmitted to the OLT 10 (upstream data) and the reception buffer (downstream buffer) 103 is a buffer to store reception data from the OLT 10 (downstream data). The PHYs 104-1 and 104-2 achieve physical interface functions, such as UNI (User Network Interface), for the terminals 200-1 and 200-2, respectively.

The redundancy switchover protection timer 100 is a timer for use in connection with a redundant OLT and may not be provided if no connection with a redundant OLT is planned. The redundancy switchover protection timer 100 measures a certain time period in order to prevent endless waiting caused by a failure to correctly receive a signal from the OLT due to an incorrect connection. Upon time-out of the redundancy switchover protection timer 100 (when no signal is received from the OLT for the certain time period or longer), the ONU 1-1 determines that there is an incorrect connection.

The operation will now be described. In the OLT 10, the OLT information is set in the setting information management unit 13 in advance. As described above, the OLT information contains the setting information for each port, and the setting information for each port contains the setting information for each ONU. The ports 11-1 to 11-n and the port control units 12-1 to 12-n are implemented, for example, in cards that are insertable into slots. One pair or a plurality of pairs of the ports 11-1 to 12-n and the port control units 12-1 to 12-n (where one pair is made up of one port and one corresponding port control unit) is implemented in one card. The OLT 10 has one or more slots. A card may be in a slot of the OLT 10 at the time of starting the OLT 10, or a card may be inserted into a slot during the operation of the OLT 10. That is, the port control units 12-1 to 11-n may be inside the OLT 10 at the time of starting the OLT 10 or may be added to the OLT 10 after the starting. Each of the port control units 12-1 to 11-n is activated when a corresponding card in which it is implemented is inserted into a slot.

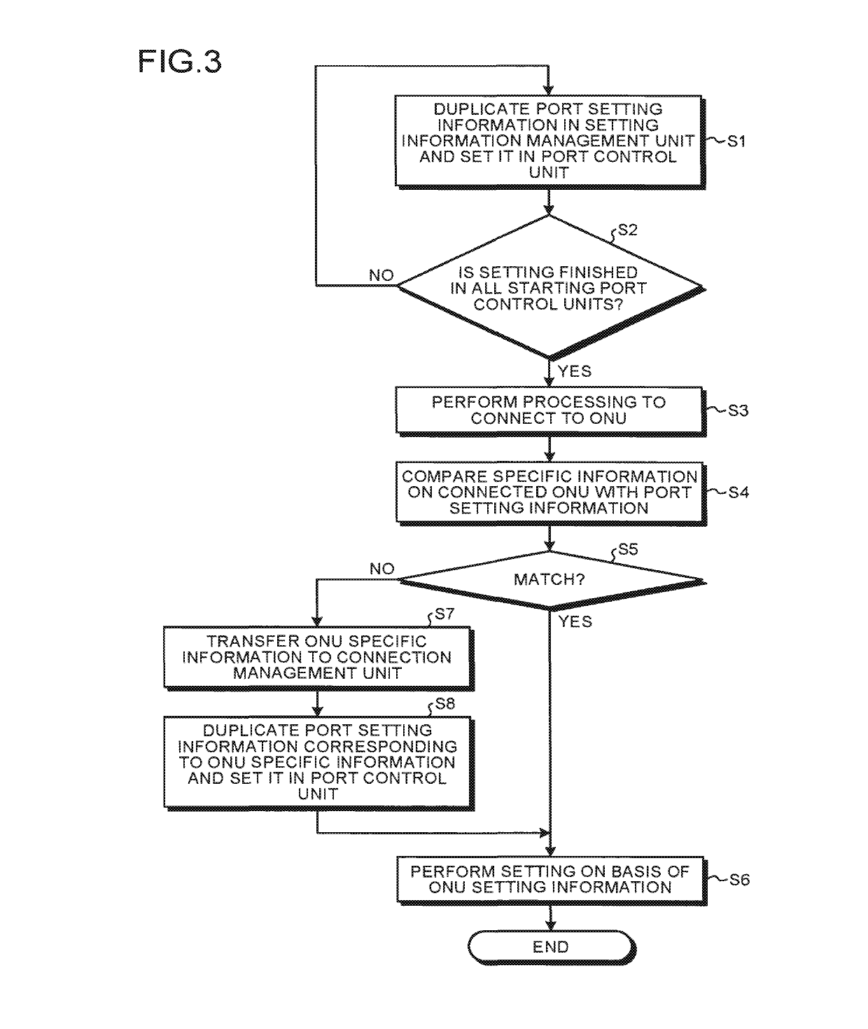

FIG. 3 is a flowchart illustrating an exemplary connection management operation of the OLT 10 according to the present embodiment. After the power of the OLT 10 is switched on, the connection management unit 14 reads from the setting information management unit 13 the port setting information corresponding to any of the port control units 12-1 to 11-n that is in the process of starting and duplicates the information, and sets the duplicated port setting information in the corresponding one of the port control units 12-1 to 11-n (step S1). For example, when the port control unit 12-1 is in the process of starting, the port 11-1 setting information in the OLT information in the setting information management unit 13 is duplicated and input to the port control unit 12-1. Upon receipt of the port setting information, the one of the port control units 12-1 to 11-n retains the port setting information in the corresponding one of the setting control units 22-1 to 22-n and executes setting for communication on the basis of the retained port setting information.

The connection management unit 14 determines whether or not setting of the port setting information (the processing in step S1) is finished in all of the port control units 12-1 to 11-n that are in the process of starting (step S2) and, if it is not finished (step S2 No), the connection management unit 14 performs step S1 on a different processing target out of the port control units 12-1 to 11-n. If setting of the port setting information is finished in all the port control units 12-1 to 11-n that are in the process of starting (step S2 Yes), the port control units 12-1 to 11-n each start processing to connect to ONUs (step S3). Note that, although step S3 is placed after steps S1 and S2 in FIG. 3, steps S3 and beyond may be performed on the port control units 12-1 to 11-n in the order in which the port control units 12-1 to 11-n are set with the port setting information, instead of waiting until setting of the port setting information is finished in all the port control units 12-1 to 11-n that are in the process of starting.

The processing in step S4 and beyond will be described below using the port control unit 12-1 as an example; however, similar processing is performed on any one of the port control units 12-1 to 11-n that is in the process of starting. The OLT 10 receives a signal transmitted by an ONU during the processing to connect to the ONU, and this signal stores specific information on the source ONU. The control unit 24-1 extracts the specific information on the source ONU from the signal received from the ONU via the optical transceiver 23-1 and passes the information to the apparatus identification unit 21-1. The apparatus identification unit 21-1 compares the specific information on the ONU received from the control unit 24-1 (the specific information received from the connected ONU) and ONU specific information contained in the port setting information (step S4). If there is a match (if the port setting information contains ONU setting information that matches the ONU specific information received from the control unit 24-1) (step S5 Yes), the apparatus identification unit 21-1 performs setting for the communication with the ONU on the basis of the ONU setting information (step S6).

This enables the ONU to operate on the basis of the setting information set by an operator or the like in the setting information management unit 13 of the OLT 10. In the case of an incorrect connection of an optical fiber during maintenance or the like, the ONU is connected to a port different from the port intended by the operator. For example, when an operator performs setting such that the ONU 1-1 is connected to the port control unit 12-1, the setting control unit 22-1 of the port control unit 12-1 retains the ONU 1-1 setting information; however, the setting control unit 22-2 of the port control unit 12-2 does not retain the ONU 1-1 setting information. If the optical fiber 51-1 is inadvertently connected to the port 11-2 with such a setting, the apparatus identification unit 21-2 of the port control unit 12-2 determines in step S5 that there is no match.

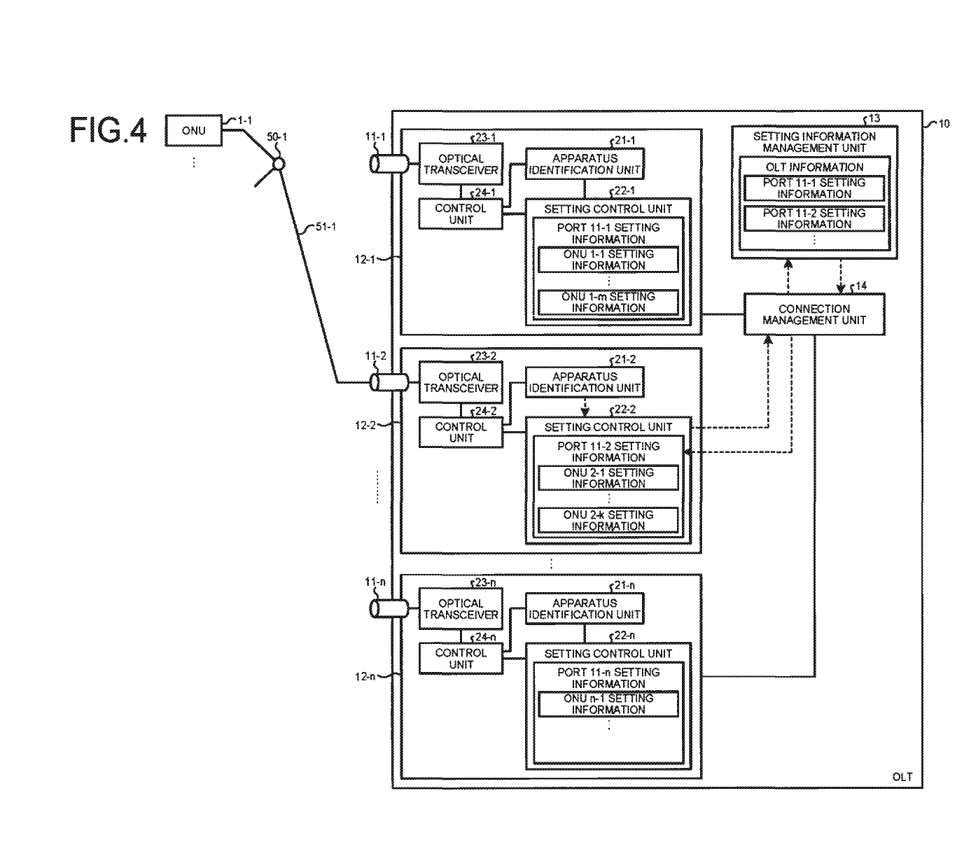

FIG. 4 is a diagram illustrating the flow of processing within the OLT 10 in the case of an incorrect connection. In the example illustrated in FIG. 4, the optical fiber 51-1 is inadvertently connected to the port 11-2, with a setting provided such that ONU 1-1 is connected to the port control unit 12-1, as described above. With reference to FIGS. 3 and 4, the operation of the OLT 10 in the case of an incorrect connection will now be described.

If there is no match in step S5 (if the port setting information contains no ONU setting information that matches the ONU specific information received from the control unit 24-1) (step S5 No), the apparatus identification unit 21-1 transfers the ONU specific information received from the control unit 24-1 to the connection management unit 14 (step S7). That is, by transferring the ONU specific information received from the control unit 24-1, the apparatus identification unit 21-1 notifies the connection management unit 14 of a request to change the setting information. The connection management unit 14 recognizes that the port to which the ONU corresponding to the transferred specific information is connected to is different from the port to which it is set to be connected (there is an incorrect connection), searches the OLT setting information in the setting information management unit 13, and extracts port setting information that contains the ONU setting information containing the transferred specific information. The connection management unit 14 then duplicates the extracted port setting information and sets the information in one of the port control units 12-1 to 11-n that has transferred the specific information (step S8). The one of the port control units 12-1 to 11-n that has received the new port setting information performs a setting on the basis of the new port setting information to execute step S6.

For example, in the example of FIG. 4, the apparatus identification unit 21-2 of the port control unit 12-2 transfers the specific information on the ONU 1-1 to the connection management unit 14. The connection management unit 14 duplicates the port 11-1 setting information and sets the information in the port control unit 12-2. This enables the port control unit 12-2 to perform communication.

The connection management unit 14 monitors for insertion of a card into a slot and, when it detects the insertion of a card into a slot, processing similar to that illustrated in FIG. 3 is performed on any of the port control units 12-1 to 12-n that is mounted in the card, in addition to when the OLT 10 is started.

By performing the operation described above, service can be commenced without correcting the port connection of an optical fiber even in the case of an incorrect port connection. In addition to the case of an incorrect connection, when an additional card is placed in a slot and the port for an GNU to connect to is intentionally changed from one to which the ONU has been connected to another in the additional card, the port control unit in the additional card can communicate with the ONU without changing the setting information.

As described above, each of the port control units 12-1 to 12-n compares the ONU setting information it retains and a signal received from an ONU and, if it determines that it does not retain GNU setting information corresponding to the connected ONU, notifies the connection management unit 14 of the information on the connected GNU in the present embodiment. The connection management unit 14 then sets port setting information that contains the ONU setting information corresponding to the ONU of the notification in the one of the port control units 12-1 to 12-n that has notified. Hence, even in a case of an incorrect connection, the service can be commenced properly without an operator for operation and maintenance correcting the connection error. This allows a reduction in operation and maintenance time to correct a connection error.

### Second Embodiment

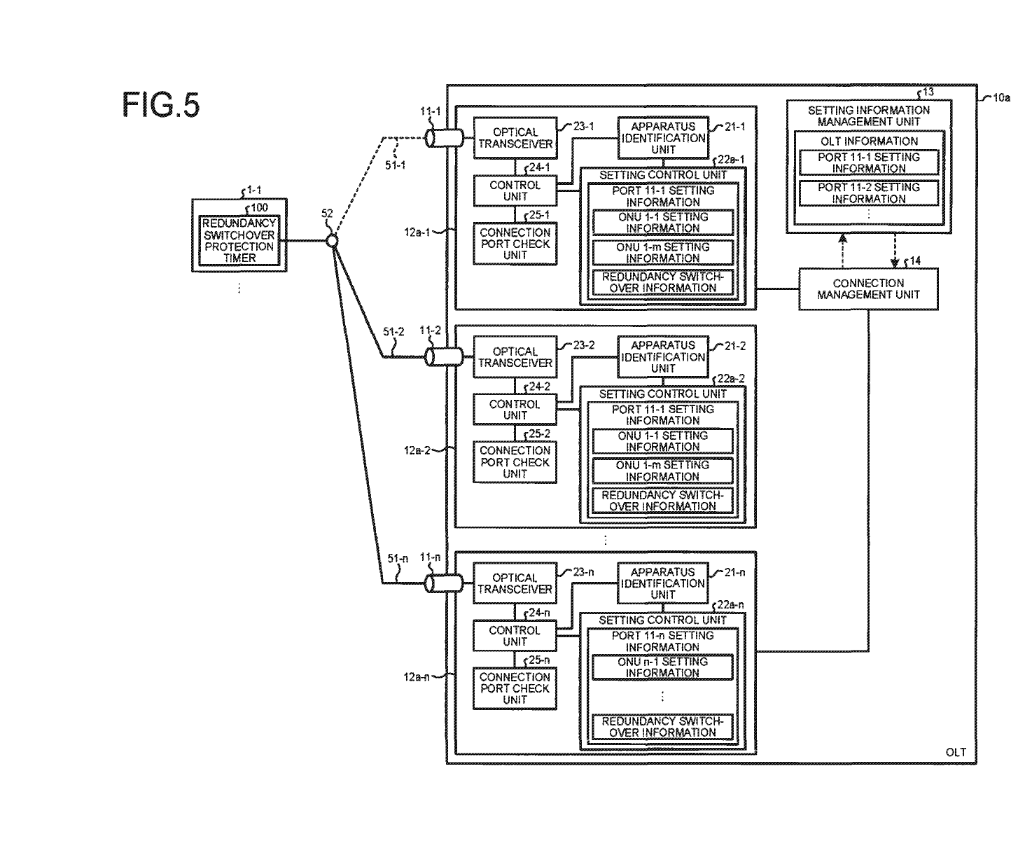

FIG. 5 is a diagram illustrating an exemplary configuration of a PON system according to a second embodiment of the present invention. The PON system according to the present embodiment includes the ONUs 1-1 to 1-m, an OLT 10a, and a splitter 52. The configurations of the ONUs 1-1 to 1-m are similar to that of the ONU 1-1 according to the first embodiment. Components having functions similar to those in the first embodiment are designated with identical symbols to the first embodiment, and duplicated description is omitted. Differences from the first embodiment will be described below.

In the first embodiment, the ONU setting information is relocated to enable the commencement of communication in the case of an incorrect connection. In the present embodiment, a method to prevent a link disconnection due to an incorrect connection will be described for a configuration including redundant trunk fibers, ports, and port control units.

In the present embodiment, the splitter 52 is to be connected to the ONU 1-1 to ONU 1-m and connected to the OLT 10a by the optical fibers 51-1 to 51-n. One or more sets of the optical fibers 51-1 to 5-n, the ports 11-1 to 11-n, and port control units 12a-1 to 12a-n are of an operational system, and another one or more sets of them are of a redundant system. An example will be described here in which n=3, and the optical fiber 51-1, the port 11-1, and the port control unit 12a-1 constitute an operational system #1, the optical fiber 51-3, the port 11-3, and the port control unit 12a-3 constitute an operational system #2, and the optical fiber 51-2, the port 11-2, and the port control unit 12a-2 constitute a redundant system.

The OLT 10a includes the ports 11-1 to 11-n, the port control units 12a-1 to 12a-n, the setting information management unit 13, and the connection management unit 14. The port control units 12a-1 to 12a-n are similar to the port control units 12-1 to 12-n of the first embodiment, except for connection port check units (port check units) 25-1 to 25-n added to the port control units 12-1 to 12-n, respectively, and setting control units 22a-1 to 22a-n replacing the setting control units 22-1 to 22-n, respectively.

The setting control units 22a-1 to 22a-n retain, as the port setting information, redundancy switchover information in addition to the ONU setting information described in the first embodiment. It is determined whether or not a subscriber apparatus responds to a bandwidth allocation notification within a certain time period, and, if there is no response within the certain time period, the connection management unit 14 is requested to acquire port setting information corresponding to another port.

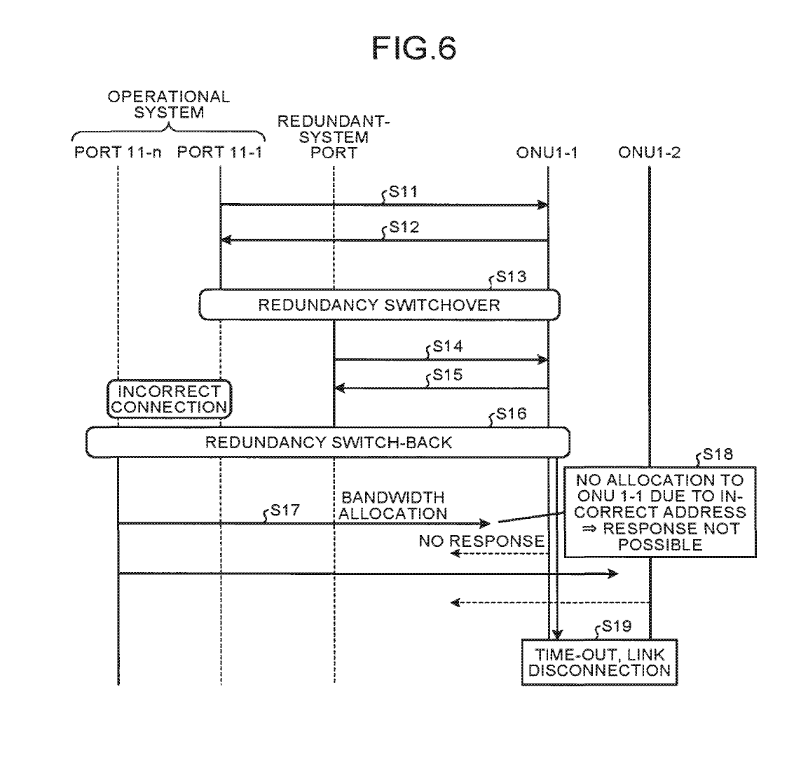

An operation according to the present embodiment will now be described. The operation of the OLT 10a at the time of starting according to the present embodiment is similar to that of the OLT 10 at the time of starting according to the first embodiment. FIG. 6 is a chart diagram illustrating an example in which a link disconnection occurs due to an incorrect connection after a redundancy switchover. In the example illustrated in FIG. 6, a link disconnection occurs due to an incorrect connection after a redundancy switchover in an example configuration in which the port 11-1 and the port 11-n are operational-system ports and the port 11-2 is a redundant-system port (redundant port) as illustrated in FIG. 5.

It is assumed that the ONUs 1-1 to 1-m are connected to the operational-system port 11-1. Here, the setting control unit 22a-1 of the port control unit 12-1 retains the ONU 1-1 setting information, and the OLT 10a sets communication with the ONU 1-1 on the basis of the correct setting information. The control unit 24-1 of the OLT 10a allocates a bandwidth for the upstream communication to the ONU 1-1 and transmits a bandwidth allocation notification periodically (step S11). The ONU 1-1 transmits a response to the bandwidth allocation notification (step S12).

A redundancy switchover is performed in which the port for the ONUs 1-1 to 1-m to connect to is changed from the port 11-1 to the port 11-2 (step S13). The port 11-2 is set as a redundant system for the port 11-1, and the setting control unit 22a-2 retains an identical duplicate of the port 11-1 setting information. Hence, the control unit 24-2 of the OLT 10a allocates a bandwidth for the upstream communication to the ONU 1-1 on the basis of the ONU 1-1 setting information and transmits a bandwidth allocation notification after the redundancy switchover (step S14). The ONU 1-1 transmits a response to the bandwidth allocation notification (step S15).

Then, a redundancy switch-back (a switchover from the redundant system back to the operational system) is performed (step S16). Although the intention with the redundancy switch-back is to change the port for the ONUs 1-1 to 1-m to connect to from the port 1-2 back to the port 11-1, it is assumed here that an incorrect connection is made during this redundancy switch-back, in which the ONUs 1-1 to 1-m are connected to the port 11-n. The control unit 24-n corresponding to the port 11-n retains the port 11-n setting information, which retains setting information for the ONU n-1 and the like, not the setting information for the ONUs 1-1 to 1-n. Hence, the control unit 24-n corresponding to the port 11-n allocates a bandwidth for the upstream communication to the ONU 1-1 on the basis of the ONU n-1 setting information and transmits a bandwidth allocation notification (step S17). This bandwidth allocation notification, which has an incorrect address (ONU n-1), is not received by the control unit 105 of the ONU 1-1 (step S18). This causes the redundancy switchover protection timer 100 in the ONU 1-1 to reach time-out and thereby the control unit 105 to determine that there is an incorrect connection and disconnect the link between the ONU 1-1 and the OLT 10a (step S19). This results in an interruption of the service to the ONU 1-1.

In the present embodiment, if there is no response from an ONU to a bandwidth allocation notification after the switch-back from a redundant system, one of the port control units 12a-1 to 12a-n of the OLT 10a functioning as an operational system transmits a bandwidth allocation notification on the basis of port setting information of another port in order to prevent such a link disconnection. The one of the port control units 12a-1 to 12a-n then requests the connection management unit 14 to perform data relocation such that the port setting information with which a response is obtained from the ONU is set in the one of the port control units 12a-1 to 12a-n. The connection management unit 14 sets the port setting information in the one of the port control units 12a-1 to 12a-n that has made the request on the basis of the request. This enables the prevention of a service interruption due to a link disconnection also in the case of an incorrect connection made during a redundancy switch-back.

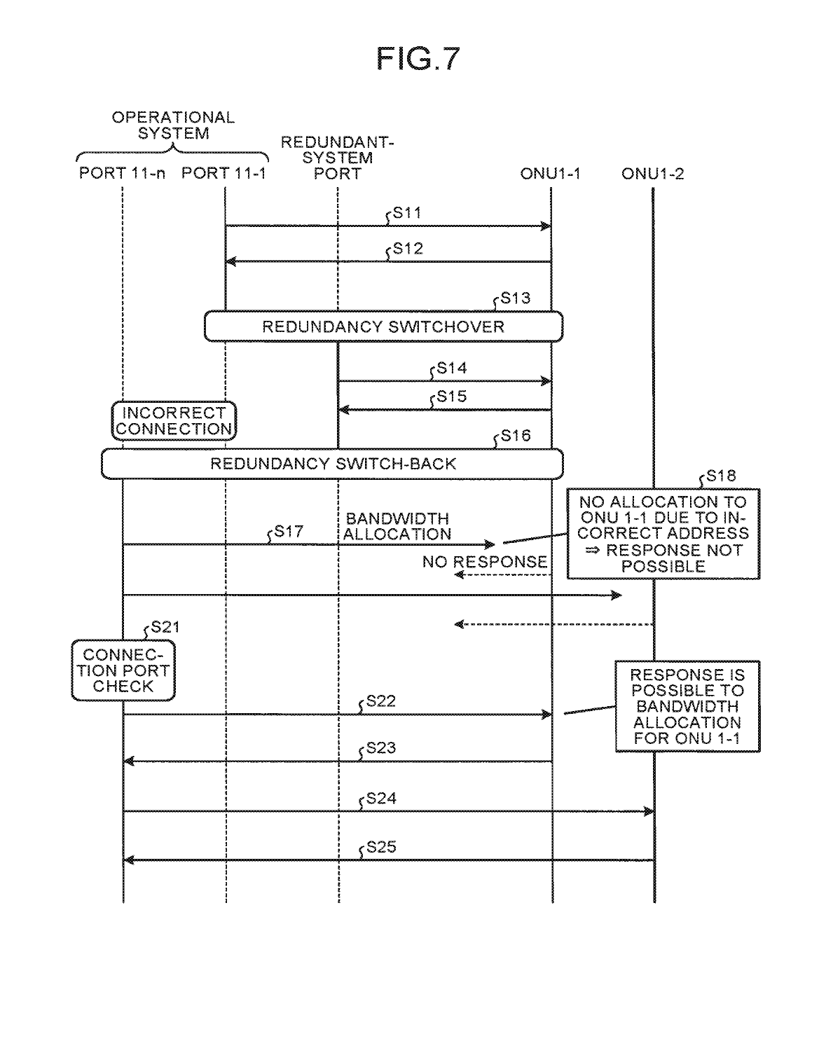

FIG. 7 is a chart diagram illustrating an exemplary operation according to the present embodiment after the switch-back from the redundant system. Steps S11 to S17 are similar to those in FIG. 6. After the transmission of a bandwidth allocation notification in step S17, the control unit 24-n of the OLT 10a requests the connection port check unit 25-n to perform a port check if there is no response received from the ONU 1-1 within a certain time period. The connection port check unit 25-n performs a port check in accordance with the request from the control unit 24-n (step S21). In this port check, the connection port check unit 25-n performs the processing below. The connection port check unit 25-n requests the connection management unit 14 to acquire port setting information of a port that is not the port 11-n, for which the setting information is retained in the setting control unit 22a-n at present (for example, port 11-1). The connection management unit 14 reads the requested port setting information from the setting information management unit 13, duplicates the information, and passes it to the connection port check unit 25-n. The connection port check unit 25-n stores the port setting information received from the connection management unit 14 as redundancy switchover information in the setting control unit 22a-n. In the example in FIG. 7, the port 11-1 setting information is stored as the redundancy switchover information.

The control unit 24-n performs the ONU bandwidth allocation by using the redundancy switchover information stored in the setting control unit 22a-n during the port check in step S21 and transmits a bandwidth allocation notification to the ONU 1-1 (step S22). This bandwidth allocation notification is transmitted to the correct address because the redundancy switchover information contains the ONU 1-1 setting information. Hence, the ONU 1-1 transmits a response to the bandwidth allocation notification (step S23). The control unit 24-n transmits a bandwidth allocation notification to the ONU 1-2 in a similar manner (step S24). The ONU 1-2 transmits a response to the bandwidth allocation notification (step S25). Because a response is obtained from the ONU 1-1, the connection port check unit 25-n requests the connection management unit 14 to set the port 11-1 setting information in the port control unit 12a-n, and the connection management unit 14 sets the port 11-1 setting information in the port control unit 12a-n on the basis of the request. In this manner, the setting control unit 22a-n retains the port 11-1 setting information so that the communication can be continued from this point on.

If there is no response from an ONU within the certain time period to andwidth allocation notification transmitted by using the redundancy switchover information, the connection port check unit 25-n requests the connection management unit 14 to obtain port setting information of still another port. Then, this port setting information is used as the redundancy switchover information to perform step S22.

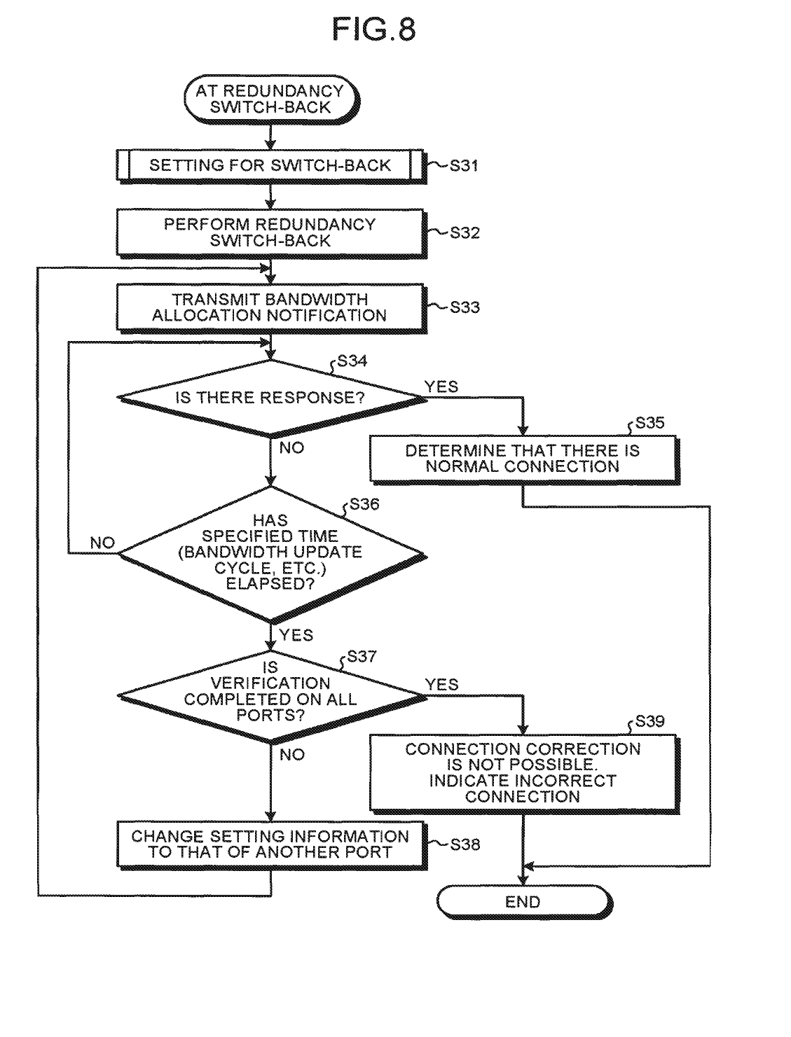

FIG. 8 is a flowchart illustrating an exemplary operation of the OLT 10a during a redundancy switch-back. The setting for a redundancy switch-back is performed (step S31). Specifically, the port setting information that corresponds to a port control unit corresponding to a port that is planned to be connected to an ONU after a switch-back is set in the port control unit. In the case of the example in FIG. 7, the port 11-1 setting information is set in the port control unit 11-1.

Then, the redundancy switch-back is performed (step S32). A control unit in a port control unit that corresponds to a port to which the GNU is connected after the switch-back transmits a bandwidth allocation notification to the ONU (step S33). For example, the control unit 24-n transmits a bandwidth allocation notification to the ONU 1-1 in the example in FIG. 7.

The control unit of the port control unit determines whether or not there is a response from the ONU (step S34) and, if there is a response (step S34 Yes), determines that there is a normal connection (step S35) and ends the processing for the switch-back. The normal communication is continued from this point on. If there is no response from the ONU (step S34 No), it is determined whether or not a specified time (a certain time period of, for example, a bandwidth update cycle) has elapsed (step S36). The bandwidth update cycle is a cycle at which the OLT 10a performs bandwidth allocation, and the OLT in general transmits a bandwidth allocation notification at every bandwidth update cycle. If the specified time has not elapsed (step S36 No), the flowchart reverts back to step S34.

If the specified time has elapsed (step S36 Yes), the control unit notifies the connection port check unit of the elapsing, and the connection port check unit determines whether or not verification (the port check) is completed on all the ports (step S37). If the verification is not completed on all the ports (step S37 No), the verification is targeted at a different port (step S38), and the flowchart reverts back to step 33. If the verification is completed on all the ports (step S37 Yes), it is determined that connection correction (which is to continue the communication by using the setting information of another port) is not possible, an incorrect connection is indicated (step S39), and the processing for the switch-back ends. An incorrect connection may be indicated in any manner; for example, an operation administrator may be notified with an indication on a screen or by an alarm sounding, or, in the case of the OLT 10a connected to a higher-level management device, the management device may be notified.

The port check may be performed immediately after the switch-back from the redundancy; alternatively, if it takes time to shift the setting information, a switchover may be performed back to the redundant system such that, while the ONU is connected to the redundant system, the setting information is shifted, and after the completion of shifting of the setting information, another switch-back is performed.

In the present embodiment, the OLT 10a determines whether or not there is an incorrect connection on the basis of the presence or absence of a response to a bandwidth allocation notification; however, the bandwidth allocation notification is not a limitation and any signal may be used as along as it is a transmission signal requesting a response.

As described above, in the present embodiment, if there is no response from an ONU to a bandwidth allocation notification at a redundancy switch-back, the OLT 10a transmits a bandwidth allocation notification by using setting information of another port and sets the setting information of a port with which a response can be obtained from an ONU. In this manner, it is possible to avoid a service interruption due to a connection error of an optical fiber for a configuration having redundancy and restart the operation with appropriate setting information relocated.

In the present embodiment, in the case where an incorrect connection is detected at a redundancy switch-back, the connection port check unit requests the connection management unit 14 to acquire the setting information of one other port at a time; however, the connection management unit 14 may set in advance port setting information corresponding to a plurality of ports in a corresponding one of the port control units 12-1 to 12-n. In this manner, the speed at which setting information of another port is acquired can be increased in the case of an incorrect connection made during a redundancy switch-back, such that the correct setting information can be identified at a higher speed.

### Third Embodiment

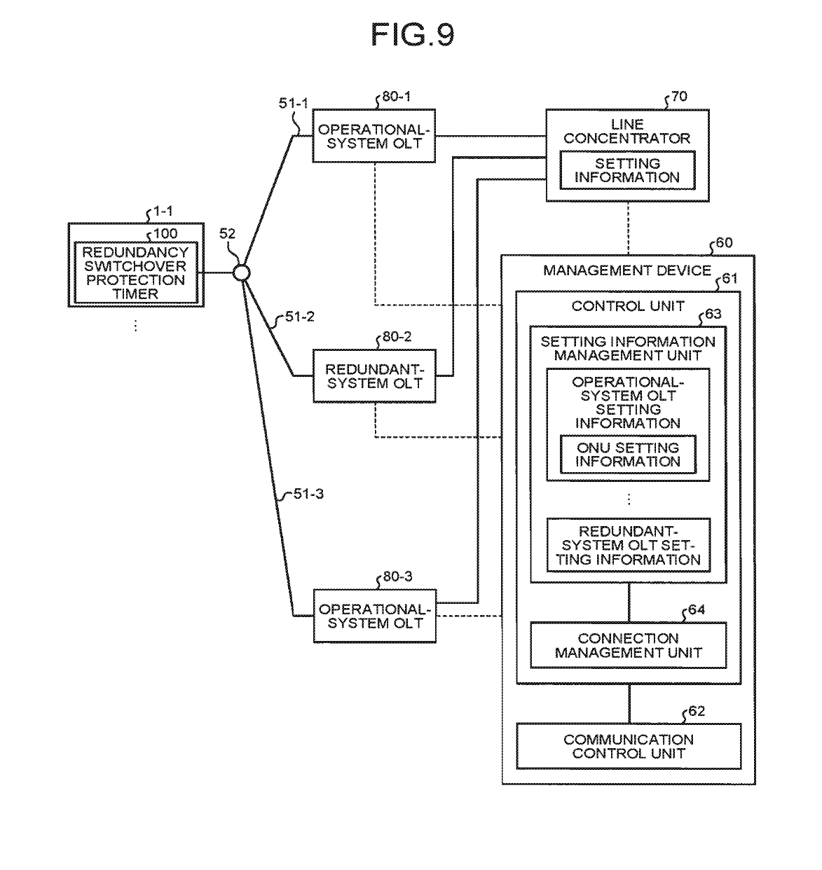

FIG. 9 is a diagram illustrating an exemplary configuration of a PON system according to a third embodiment of the present invention. The PON system according to the present embodiment includes the ONUs 1-1 to 1-m, operational-system OLTs 80-1 and 80-3, a management device 60, and a line concentrator 70. The configurations of the ONUs 1-1 to 1-m are similar to that of the ONU 1-1 in the first embodiment. Components having functions similar to those in the first or second embodiment are designated with identical symbols to the first or second embodiment, and duplicated description is omitted. Differences from the first or second embodiment will be described below.

In the first and second embodiments, the OLT includes a plurality of ports, and a port control unit for each port controls ONUs connected to an optical fiber that is connected to the port. In the present embodiment, a configuration will be described in which the optical fibers 51-1 to 51-3 are connected to different OLTs. The operational-system OLTs 80-1 and 80-3 have configurations similar to that of one of the port control units 12a-1 to 12a-n of the OLT 10a in the second embodiment. The redundant-system OLT 80-2 has a configuration similar to those of the operational-system OLTs 80-1 and 80-3. The operations of the components of the operational-system OLTs 80-1 and 80-3 and the redundant-system OLT 80-2 are similar to those of the components of the port control units 12a-1, 12a-n, and 12a-2 of the second embodiment.

The management device 60 includes a control unit 61 and a communication control unit 62. The control unit 61 includes a setting information management unit 63 and a connection management unit 64. The setting information management unit 63 retains operational-system OLT setting information and redundant-system OLT information on an OLT-by-OLT basis. These pieces of the OLT setting information are information corresponding to the port setting information retained in the setting information management unit 13 of the first and second embodiments. The operational-system OLT setting information and the redundant-system OLT setting information are set by an operation administrator or the like.

The line concentrator 70 retains setting information. When the line concentrator 70 is started, the connection management unit 64 sets in the line concentrator 70 OLT setting information for an OLT connected to the line concentrator 70. For example, in a case in which the line concentrator 70 is connected to the operational-system OLTs 80-1 and 80-3 and the redundant-system OLT 80-2, the line concentrator 70 acquires the OLT setting information of the operational-system OLTs 80-1 and 80-3 and the redundant-system OLT 80-2 from the management device 60 and retains it.

When the operational-system OLTs 80-1 and 80-3 and the redundant-system OLT 80-2 are started, the line concentrator 70 sets the OLT setting information corresponding to these OLTs in the respective operational-system OLTs 80-1 and 80-3 and the redundant-system OLT 80-2. The operational-system OLTs 80-1 and 80-3 and the redundant-system OLT 80-2 communicate with ONUs in a similar manner to the port control units in the second embodiment by using the OLT setting information set by the line concentrator 70. Then, at a redundancy switch-back, it is determined whether or not there is an incorrect connection on the basis of the presence or absence of a response to a bandwidth allocation notification, as in the second embodiment. When there is an incorrect connection, the connection port check unit of one of the operational-system OLTs 80-1 and 80-3 requests the management device 60 to acquire setting information of another OLT, as in step S21 of the second embodiment. Upon acquiring this request via the communication control unit 62, the connection management unit 64 of the management device 60 transmits the requested OLT setting information to the one of the operational-system OLTs 80-1 and 80-3 that has made the request. The one of the operational-system OLTs 80-1 and 80-3 transmits a bandwidth allocation notification by using the OLT setting information received from the management device 60 in a similar manner to the port control unit 12a-n in the second embodiment. If there is a response from an ONU, the one of the operational-system OLTs 80-1 and 80-3 requests the management device 60 to set the OLT setting information with which the response is obtained. The management device 60 updates the setting information in the line concentrator 70 on the basis of the request. For example, if the operational-system OLT 80-3 detects an incorrect connection made during a redundancy switch-back and obtains an ONU response by using the setting information of the operational-system OLT 80-1, the management device 60 changes the setting information of the operational-system OLT 80-3 contained in the setting information in the line concentrator 70 to the setting information of the operational-system OLT 80-1. The line concentrator 70 sets the new setting information for the operational-system OLT 80-3 (the setting information of the operational-system OLT 80-1) in the operational-system OLT 80-3.

The line concentrator 70 learns traffic information (a source MAC address) and the like received from an OLT and determines a transfer destination for a frame received from a higher-level network on the basis of the information of the target MAC address of the frame and by using the result of learning. In a case where an OLT to connect to is switched as in the present embodiment, the line concentrator 70 is also required to change the transfer destination for a frame received from the higher-level network. Hence, the line concentrator 70 switches the transfer destination for a frame on the basis of a notification from the management device 60. Specifically, the management device 60 notifies the line concentrator 70 of an instruction for the line concentrator 70 to switch the transfer destination to the redundant-system OLT 80-2 and an instruction to switch back from the redundant system (for the line concentrator 70 to change the transfer destination from the redundant-system OLT 80-2 back to the operational-system OLT 80-1). When there is no incorrect connection, these notifications enable the line concentrator 70 to transfer a frame to the correct transfer destination. If there is an incorrect connection, the management device 60 also notifies the line concentrator 70 of a change of the setting information. This enables the line concentrator 70 to switch the transfer destinations. For example, as in the case described above where the setting information of the operational-system OLT 80-1 is set in the operational-system OLT 80-3 in accordance with the notification from the operational-system OLT 80-3, the management device 60 also notifies the line concentrator 70 to change the setting information of the operational-system OLT 80-3 to the setting information of the operational-system OLT 80-1. This enables the line concentrator 70 to switch the transfer destination for a frame addressed to the ONU 1-1. That is, the line concentrator 70 is enabled to transfer a frame addressed to the ONU 1-1, which should have been connected such that it is subordinate to the operational-system OLT 80-1, to the operational-system OLT 80-3, which is connected to the ONU 1-1 due to the incorrect connection.

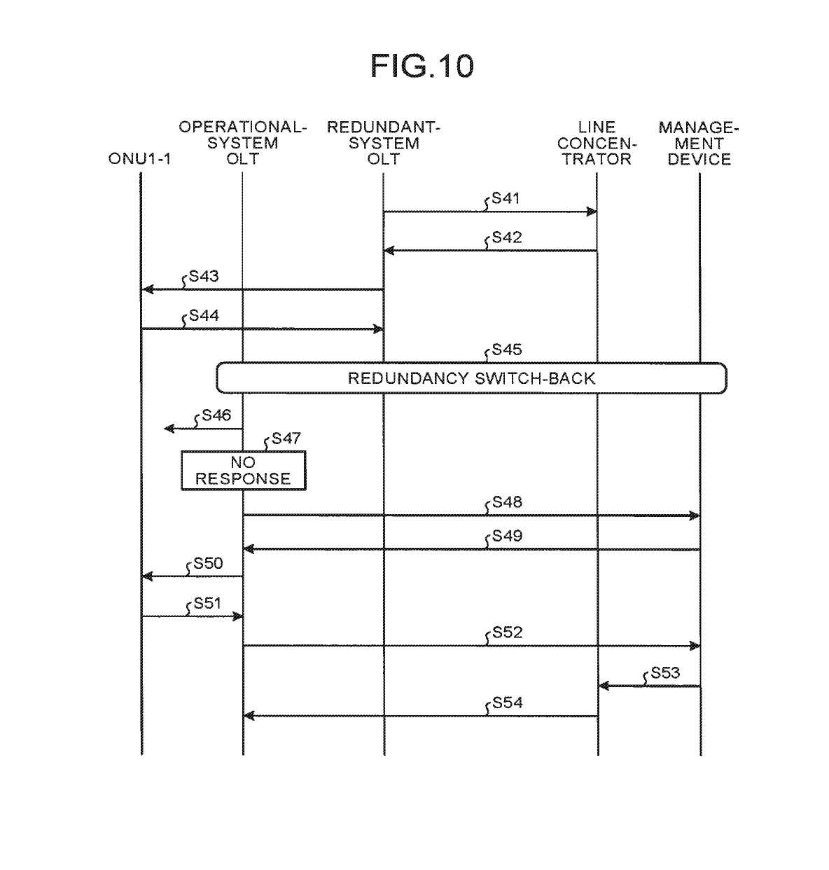

FIG. 10 is a chart diagram illustrating an exemplary operation according to the present embodiment in the case of an incorrect connection made during a redundancy switch-back. Upon starting for a redundancy switchover, the redundant-system OLT 80-2 notifies the line concentrator 70 of the starting (step S41), and the line concentrator 70 notifies the redundant-system OLT 80-2 of the setting information of the operational-system OLT 80-1 on the basis of the retained setting information (step S42). It is assumed that the setting is made in advance such that the redundant-system OLT 80-2 should operate as a redundant system for the operational-system OLT 80-1.

The redundant-system OLT 80-2 transmits a bandwidth allocation notification to the ONU 1-1 using the setting information set by the line concentrator 70 (step S43). The ONU 1-1 transmits a response to the bandwidth allocation notification (step S44). A redundancy switch-back is then performed (step S45). The ONU 1-1 is connected to an incorrect operational-system OLT due to an incorrect connection. it is assumed here that, while the ONU 1-1 should be connected to the operational system 80-1, it is connected to the operational-system OLT 80-3.

The operational-system OLT 80-3 transmits a bandwidth allocation notification for the ONU 1-1 on the basis of the retained setting information (step S46). This bandwidth allocation notification, which is transmitted on the basis of the incorrect setting information, does not reach the ONU 1-1. The operational-system OLT 80-3 determines that there is no response because no response to the bandwidth allocation notification arrives within a certain time period (step S47) and requests the management device 60 to acquire setting information of another OLT (step S48).

The management device 60 notifies the operational-system OLT 80-3 of the setting information of the other OLT (the operational-system OLT 80-1) on the basis of the request (step S49). The operational-system OLT 80-3 transmits a bandwidth allocation notification for the ONU 1-1 on the basis of the notified setting information (step S50). Because this bandwidth allocation notification is transmitted on the basis of the correct setting information, the ONU 1-1 transmits a response to the bandwidth allocation notification (step S51). The operational-system OLT 80-3 obtains the response to the bandwidth allocation notification and thus requests the management device 60 to set the setting information of the operational-system OLT 80-1 in the operational-system OLT 80-3 (step S52). The management device 60 changes the setting information in the line concentrator 70 on the basis of the request (step S53), and the line concentrator 70 sets the new setting information in the operational-system OLT 80-3 (step S54).

As in the first embodiment, each of the operational-system OLTs 80-1 and 80-3 may compare the ONU setting information it retains with a signal received from an ONU, and, if it determines that it does not retain ONU setting information corresponding to the connected ONU, it may notify the management device 60 of the information on the connected ONU. The connection management unit 64 then may set OLT setting information that contains the ONU setting information corresponding to the ONU of the notification as the corresponding OLT information in the setting information in the line concentrator 70.

In the present embodiment, the setting information in the management device 60 is set in each OLT via the line concentrator 70; however, no line concentrator 70 may be provided, in which case the management device 60 may directly set the information in each OLT.

As described above, in the present embodiment, with the configuration that includes a plurality of OLTs that are connected to the line concentrator 70 and the management device 60, the management device 60 includes the setting information management unit and the connection management unit and manages the relocation of the setting information. Therefore, with the configuration that includes a plurality of OLTs, it is possible to avoid a service interruption due to a connection error between an OLT and an ONU and restart the operation with appropriate setting information relocated.

### INDUSTRIAL APPLICABILITY

As described above, a master-station apparatus, a slave-station apparatus, a control device, an optical communication system, and a connection management method according to the present invention are useful for a PON system and in particular suitable for a PON system in which a target ONU for connection can be changed.

### REFERENCE SIGNS LIST

1-1 to 1-m and 2-1 to 2-k ONU, 10 and 10a OLT, 50-1, 50-2, and 52 splitter, 51-1 to 51-n optical fiber, 11-1 to 11-n port, 12-1 to 12-n and 12a-1 to 12a-n port control unit, 13 and 63 setting information management unit, 14 and 64 connection management unit, 21-1 to 21-n apparatus identification unit, 22-1 to 22-n and 22a-1 to 22a-n setting control unit, 23-1 to 23-n and 101 optical transceiver, 24-1 to 24-n, 61, and 105 control unit, 25-1 to 25-n connection port check unit, 60 management device, communication control unit, 70 line concentrator, 80-1 and 80-3 operational-system OLT, 80-2 redundant-system OLT, 100 redundancy switchover protection timer, 102 transmission buffer, 103 reception buffer, 104-1 and 104-2 PHY.

1: A master-station apparatus comprising a plurality of ports connectable to an optical communication path connected to a slave-station apparatus, the master-station apparatus comprising:
port control units for the respective ports, the port control units receiving a signal via the ports from the slave-station apparatus and transmitting a signal via the ports to the slave-station apparatus;
a setting information management unit that manages, for each of the ports, setting information for use in communication with the slave-station apparatus to be connected to the ports; and
a connection management unit that sets the setting information managed by the setting information management unit in the port control unit, wherein
the port control unit determines whether or not the setting information be changed on a basis of a signal received from the slave-station apparatus and the setting information that has been set and, when it is determined that the setting information be changed, notifies the connection management unit of a request to change the setting information, and
the connection management unit selects setting information to be set in the port control unit from the setting information management unit on a basis of a notification from the port control unit and sets the selected setting information in the port control unit.

2: The master-station apparatus according to claim 1, wherein
the setting information contains specific information on the slave-station apparatus that is set to be connected to the port, and
the port control unit extracts, from a signal received from the slave-station apparatus, specific information on the source slave-station apparatus and determines whether or not the setting information be changed on a basis of a result of comparison between the extracted specific information and the specific information contained in the setting information that has been set.

3: The master-station apparatus according to claim 2, wherein
the port control unit comprises:
a setting control unit that retains the setting information that has been set; and
an apparatus identification unit that changes the setting information on a basis of a result of comparison between the extracted specific information and the specific information contained in the setting information that has been set.

4: The master-station apparatus according to claim 1, wherein
at least one port among the ports and the port control unit corresponding to the port are used as a redundant system,
a port except the port of the redundant system and a port control unit except the port control unit of the redundant system are used as an operational system,
after the port to be connected to the slave-station apparatus is switched from the port of the operational system to the port of the redundant system, the port to be connected to the slave-station apparatus is switched to the port of the operational system, and, then, the port control unit corresponding to the port connected after switching transmits to the slave-station apparatus a signal requesting a response and, when no response to the signal is received within a certain time period, requests the connection management unit to acquire the setting information that is different from the setting information set in the port control unit,
the connection management unit inputs in the port control unit the setting information that is different from the setting information set in the port control unit on a basis of a request from the port control unit, and
the port control unit transmits to the slave-station apparatus a signal requesting a response on a basis of the setting information input from the connection management unit.

5: The master-station apparatus according to claim 4, wherein, when the port control unit receives a response to the signal transmitted to the slave-station apparatus on a basis of the setting information input from the connection management unit, the port control unit requests the connection management unit to set the setting information in the port control unit and, when the port control unit receives no response to the signal transmitted to the slave-station apparatus on a basis of the setting information input from the connection management unit within a certain time period, the port control unit requests the connection management unit to acquire the setting information having not been input to the port control unit, and transmits to the slave-station apparatus a signal requesting a response on a basis of the setting information input from the connection management unit.

6: The master-station apparatus according to claim 4, wherein the connection management unit inputs to the port control unit two or more pieces of the setting information that are different from the setting information set in the port control unit on a basis of a request from the port control unit.

7: The master-station apparatus according to claim 4, wherein
the port control unit comprises:
a setting control unit that retains the setting information that has been set; and
a connection port check unit that requests the connection management unit to acquire the setting information that is different from the setting information set in the port control unit when no response to a signal requesting a response is received within a certain time period.

8: The master-station apparatus according to claim 4, wherein the signal requesting a response is a bandwidth allocation notification.

9: A slave-station apparatus to be connected to the master-station apparatus according to claim 1 via an optical communication path, the master-station apparatus comprising a plurality of ports, the optical communication path being connected to the ports, wherein,
when the slave-station apparatus receives a signal requesting a response from the master-station apparatus, the slave-station apparatus transmits a response to the signal to the master-station apparatus.

10: A control device in a master-station apparatus that comprises a plurality of ports connectable to an optical communication path connected to a slave-station apparatus, the control device comprising
at least one port control unit that receives setting information for use in communication with the slave-station apparatus, receives a signal from the slave-station apparatus via one of the ports, transmits a signal to the slave-station apparatus via the port, determines whether or not the setting information be changed on a basis of a signal received from the slave-station apparatus and the setting information, and, when it is determined that the setting information be changed, issues a notification of a request to change the setting information.

11-12. (canceled)

13: An optical communication system that comprises a slave-station apparatus, a plurality of master-station apparatuses connectable to the slave-station apparatus, a management device that manages the master-station apparatuses, and a line concentrator connected to the master-station apparatuses and the management device, wherein
the management device comprises:
a setting information management unit that manages setting information for use in communication with the slave-station apparatus to be connected to the master-station apparatuses for each of the master-station apparatuses;
a connection management unit that selects setting information to be set in the master-station apparatuses from the setting information managed by the setting information management unit; and
a communication control unit that transmits the setting information selected by the connection management unit to the line concentrator,
the line concentrator retains the setting information received from the management device and transmits the setting information to a corresponding one of the master-station apparatuses,
the master-station apparatuses each determine whether or not the setting information be changed on a basis of a signal received from the line concentrator and the setting information received from the line concentrator and, when it is determined that the setting information be changed, transmit a request to change the setting information to the management device, and
the connection management unit selects the setting information to be set in the master-station apparatus from the setting information management unit on a basis of a request to change the setting information from the master-station apparatus.

14. (canceled)
